(19) United States
(12) Patent Application Publication
(10) Pub. No.: US 2024/0404253 A1
(43) Pub. Date: Dec. 5, 2024

(54) TECHNIQUES FOR VISUAL LOCALIZATION WITH IMPROVED DATA SECURITY

(71) Applicant: APPLE INC., CUPERTINO, CA (US)

(72) Inventors: Rahul Raguram, San Carlos, CA (US); Vivek Roy, Sunnyvale, CA (US); Shashank Tyagi, Sunnyvale, CA (US); Huy Tho Ho, San Jose, CA (US); Kjell Fredrik Larsson, Santa Clara, CA (US)

(73) Assignee: APPLE INC., CUPERTINO, CA (US)

(21) Appl. No.: 18/422,713

(22) Filed: Jan. 25, 2024

Related U.S. Application Data
(60) Provisional application No. 63/470,944, filed on Jun. 4, 2023.

(51) Int. Cl. G06V 10/774; G06F 21/62; G06T 7/73; G06T 11/00; G06V 10/77; G06V 10/776; G06V 10/82

(52) U.S. Cl. CPC G06V 10/774; G06F 21/6218; G06T 7/73; G06T 11/00; G06V 10/7715; G06V 10/776; G06T 2207/20081; G06T 2207/20084; G06V 10/82

(57) ABSTRACT

Techniques are disclosed for training a feature extraction model. A computing device can receive a training image and generate noised feature vectors using a feature extraction model characterized by first parameters and taking the training image as input. The computing device can determine the noised feature vectors by at least determining a feature vector for individual pixels in the training image and applying noise to each feature vector. The computing device can generate a reconstructed image using a reconstructor model characterized by second parameters and taking the noised feature vectors as input. The computing device can determine a reconstruction loss by comparing the training image with the reconstructed image and a noise loss using the noise applied to each feature vector. The computing device can update the first parameters based on the noise loss.

CROSS-REFERENCES TO OTHER APPLICATIONS

This application claims priority to U.S. Provisional Application No. 63/470,944, for “TECHNIQUES FOR VISUAL LOCALIZATION WITH IMPROVED DATA SECURITY” filed on Jun. 4, 2023, which is herein incorporated by reference in its entirety for all purposes.

### BACKGROUND

Map applications accessible from user devices are ubiquitous, allowing users to obtain route details for driving and location information for stores, gas stations, and other destinations. Often, the information provided by the map application can include street-level detail captured by camera systems deployed by the service providers. This street-level detail can be used to help users determine their location more precisely, particularly in unfamiliar environments.

### SUMMARY

Embodiments of the present disclosure relate to visual localization. More particularly, embodiments of the present disclosure provide methods, systems, and computer-readable media that can generate new information for a visual localization system via crowdsourcing in a privacy-protected manner. By way of a non-limiting example, embodiments of the present disclosure have been applied to visual localization systems that can be used with smartphones and other similar devices having a camera, but the present disclosure has wider applicability in the machine learning.

One embodiment is directed to a computer-implemented method training a feature extraction model. The method can be performed by computer system. The method can include receiving a training image and generating noised feature vectors using a feature extraction model characterized by first parameters and taking the training image as input. The method can determine the noised feature vectors by at least determining a feature vector for individual pixels in the training image and applying noise to each feature vector. The method can also include generating a reconstructed image using a reconstructor model taking the noised feature vectors as input. The reconstructor model can be characterized by second parameters. The method can also include determining a reconstruction loss by at least comparing the training image with the reconstructed image. The method can also include determining a noise loss using the noise applied to each feature vector. The noise can be characterized by the reconstruction loss. The method can also include updating the first parameters based on the noise loss.

Another embodiment is directed to a computer implemented method for using a trained feature extraction model to generate new feature information. The method can be performed by a user device. The method can include obtaining an image of a local environment at a location of the user device. The method can also include generating noised feature vectors for individual pixels in the image. The noised feature vectors can include descriptor information for the individual pixels and noise components. The noised feature vectors can be generated using a feature extraction model that takes the image as input. The feature extraction model can be adversarially trained with a reconstructor model. The method can also include sending feature information corresponding to the local environment. The feature information can be sent to a server device and can include a subset of the noised feature vectors.

Still another embodiment is directed to a computer-implemented method for updating a database of feature information using new feature information generated by a user device. The method may be performed by a server device. The method can include maintaining feature information associated with local environments of a plurality of locations. The feature information can include feature vectors generated using images of the local environments and can be characterized by a first property. The method can also include receiving, from a user device, a request for the feature information. The request can include location information corresponding to a location. In response to receiving the request, the method may proceed by identifying, using the location information, a first set of the feature vectors corresponding to the location, and sending the first set of the feature vectors to the user device. The method can also include receiving, from the user device, new feature information generated using current images of a local environment of the location. The new feature information can be characterized by a second property different from the first property. The method can also include updating the feature information using the new feature information.

Another embodiment is directed to a computer-implemented method for performing visual localization using a feature information that includes new feature information previously generated by other user devices. The method may be performed by a user device. The method can include obtaining an image of a local environment at a location of the user device. The method can also include sending a request for feature information to a server device. The request can include location information. The method can also include receiving the feature information from the server device. The feature information can include first noised feature vectors corresponding to the location. The method can also include generating, using a feature extraction model taking the image as input, second noised feature vectors for pixels in the image. The feature extraction model may be adversarially trained with a reconstructor model. The method can also include determining the location of the user device by comparing the first noised feature vectors with the second noised feature vectors.

Additional embodiments are directed to a computing system comprising one or more processors and one or more memories storing instructions that, when executed by the one or more processors, cause the computing system to perform any of the methods described above.

Still further embodiments are directed to a non-transitory computer-readable medium storing computer-executable instructions that, when executed by one or more processors of a computing system, cause the computing system to perform any of the methods described above.

### BRIEF DESCRIPTION OF THE DRAWINGS

FIG. 1 illustrates a simplified flow chart and block diagram of a technique to generate noised feature vectors using a trained feature extraction model, according to some embodiments.

FIG. 2 illustrates an example architecture of a visual localization engine that can execute a trained feature extraction model, according to some embodiments.

FIG. 3 illustrates an example flow for adversarially training a feature extraction model, according to some embodiments.

FIG. 4 illustrates an example image with identified feature points, according to some embodiments.

FIG. 5A illustrates an example image with identifiable elements, according to an embodiment.

FIG. 5B illustrates an example reconstructed image using feature vectors and including identifiable elements, according to an embodiment.

FIG. 5C illustrates another example reconstructed image using noised feature vectors and including obfuscated elements, according to an embodiment.

FIG. 6 illustrates an example architecture of a system that can implement techniques for visual localization using noised feature vectors, according to some embodiments.

FIG. 7 illustrates an example process for training a feature extraction model, according to some embodiments.

FIG. 8 illustrates an example process for generating noised feature vectors for new images captured at a location, according to some embodiments.

FIG. 9 illustrates an example process for updating feature information for a location using noised feature vectors generated by user devices, according to some embodiments.

FIG. 10 illustrates an example process for selecting feature information for use in visual localization based a property of the feature information, according to some embodiments.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, methods, systems, devices, and computer-readable media that enable the generation of new street-level information in a privacy-protected manner, and which may be used for visual localization on a user device. Visual localization refers to methods that can determine the location and orientation of a camera (i.e., its “pose”) by comparing images of the local environment (e.g., a city street) captured by the camera with image data previously obtained by a service provider. More specifically, a visual localization system can identify distinctive visual features within an image that are useful for matching with similar features from other images of the same scene. A service provider may maintain a database of features that were identified from previously captured images of the local environment. By matching the features, the visual localization system can estimate the location of the camera when it captured the image.

The features identified in the images are typically represented by feature vectors (also referred to as feature descriptors) that encode information about a corresponding pixel and its neighboring pixels in the image. Machine learning techniques, including convolutional neural networks, deep neural networks, and the like, can be used to generate the feature vectors from an image, as well as score or rank the feature vectors based on their usefulness for matching. The visual localization system can then match the feature vectors with other feature vectors maintained by the service provider.

In many cases, a service provider may have obtained feature information for various locations by deploying camera systems to various locations to capture images of the local environment. These street-level views of cities, towns, and other locations include multiple images from a variety of different positions of buildings, houses, storefronts, street signs, trees, vehicles, people, and other objects visible from the public roads and sidewalks. The service provider can use the street-level images to build a library of feature information, including accurate locations in three dimensions of the feature points corresponding to the feature vectors. Using the three-dimensional information, when the visual localization system matches feature vectors generated from a new image, the visual localization system can triangulate the position and orientation of the camera that captured the new image, thereby providing an accurate location estimate.

However, the street-level views can change over time. Transient objects like parked cars and pedestrians that were present in the images captured initially by the service provider and used to build the feature database are unlikely to be present in a new image that a user captures with a user device at a later time. Street signs may be added, removed, or modified. Construction may alter building facades or add or remove structures in the street scape. Seasonal and weather effects can produce highly changing elements in images, including the presence or absence of rain, snow, daylight, artificial lighting, leaves on trees, and so on. Thus, when a user attempts to perform visual localization to determine their location, the images they capture may not include enough features that can be matched to the features maintained in the service provider's database. The reduced matching quality can therefore degrade the performance and accuracy of the visual localization system. The service provider could redeploy camera systems to capture updated imagery, but such redeployments can require substantial time and computational resources to process the new image data, and, due to the time cost and the vast number of locations that may be supported by the visual localization system, may not be able to keep up with the various changes outlined above.

To obtain new feature information for the various locations to support visual localization, the service provider can instead obtain the new feature vectors from user devices using the visual localization system. Because the user devices are capturing and processing the new images to produce feature vectors to be matched with feature information maintained by the service provider, the service provider can obtain the new feature vectors from image data collected by the user devices to effectively crowdsource updates to the feature database. However, the user devices may capture imagery that includes identifiable elements like people, faces, personal vehicles, license plates. Although feature vectors generated from images containing identifiable elements do not explicitly contain the identifiable information (that is to say, the feature vectors are numerical representations of image information), it may be possible to reconstruct an image using feature vectors as inputs, where the reconstructed image would contain the identifiable elements. To maintain user privacy and prevent the service provider from receiving identifiable information about the local environment of the user devices, the algorithms for visual localization run on the user devices. Sending unmodified feature vectors generated from images back to the service provider could present a risk that the service provider could use the feature vectors to reconstruct the images captured by the user devices and thereby derive identifiable information about the user devices. Additionally, the user devices may only send new feature vectors that correspond to features already identified and present within the service provider's database, and then only send the new feature vectors if the user device successfully completes visual localization. In this way, the updated feature information does not extend into non-public areas so that the service provider does not end up storing new feature information for locations that may be accessible or viewable by the user but not accessible to the service provider or the general public.

To mitigate the privacy and data security concern identified above, as well as provide other improvements to a typical visual localization system, the techniques described herein relate to methods for training a feature extraction model to produce feature vectors that have added noise. The visual localization system can use the noised feature vectors to accurately match the feature vectors maintained by the service provider, while the added noise results in reconstructed images that have obfuscated or otherwise unidentifiable features as compared to either the original image or an image reconstructed using un-noised feature vectors. Since only the noised feature vectors and related visual location feature information are sent to the service provider, neither the service provider nor any other entity that acquires the noised feature vectors is able to recreate identifiable imagery. The privacy of the user's image data, as well as the privacy of other people and identifiable objects contained in the image data, is thereby secured.

As a first particular example, a feature extraction model may be trained adversarially with a reconstruction model. The feature extraction model can include one or more convolutional neural networks (CNNs) as layers in the model to identify features in input images and generate feature vectors for the identified points. The reconstruction model can also include one or more neural networks that can generate an image using input feature vectors. Separately, each model can be trained to produce its corresponding output using supervised or unsupervised techniques, including a training model. Training each model can include modifying the parameters that characterize the layers of the CNNs based on optimizing (e.g., maximizing or minimizing) suitable loss functions computed between the generated outputs (e.g., feature vectors, reconstructed images) and known or desired outputs (e.g., known feature vectors, the input image to be reconstructed). To train the models together adversarially, the feature extraction model can be configured to add noise to the feature vectors it produces for an input image. The reconstruction model can then be trained to reconstruct an image that closely matches the input image by minimizing a reconstruction loss computed by comparing the input image with the reconstructed image. The feature extraction model can then be trained to minimize a noise loss computed using the added noise with a standard loss function (e.g., triplet loss, regularization loss) for matching the noised feature vectors and with existing feature vectors, while also maximizing the reconstruction loss that results from the reconstructed image that is output from the reconstruction model. Each model is then alternately trained for these optimizations, so that the trained feature extraction model produces noised feature vectors that, when used as inputs into an arbitrary trained image reconstruction model, produce reconstructed images that have obfuscated or unidentifiable elements. Because no entity using a reconstruction model can recreate images with identifiable elements using the noised feature vectors, the privacy of the user's image data-as well as the privacy of any pedestrians or other people in the original image data, identifiable vehicles, signs with names or phone numbers, license plates, and other identifiable information-is preserved.

As a second particular example, an adversarially trained feature extraction model can be executed on a user device as part of visual localization. A user can use the user device (e.g., their smartphone) to determine their location by capturing an image or a stream of images of their surroundings. For example, to orient themselves in an unfamiliar city, the user can capture an image of a nearby streetscape that includes buildings, building facades, signs, and the like. The user device can request feature information from a service provider that maintains feature information for the city and other locations. The user device can receive a set of feature vectors that generally correspond to the local environment. For example, the service provider may maintain feature information categorized according to relatively large geographic regions (e.g., several city blocks, etc.). When the user device requests feature information, the server device may provide feature information for the large geographic region in which the user device is when performing visual localization. The user device can then process the image using the trained feature extraction model to produce noised feature vectors that can be used to determine matching feature vectors from the information provided by the service provider. Based on the matching, the user device can determine its location and orientation to a high degree of accuracy. The user device can then send the noised feature vectors to the service provider to update or otherwise augment the feature information for that location. As the service provider receives and integrates the noised feature vectors from user devices performing visual localization, these noised feature vectors may be provided to other user devices performing visual localization as part of the set of feature vectors that generally correspond to the local environment.

As a third particular example, a service provider can maintain feature information for various locations, for instance on one or more server devices, data storage devices, and the like. This feature information may have been obtained by the service provider by deploying camera systems (e.g., vehicles with camera and light detection and ranging (LIDAR) arrays on the roof, pedestrians with camera array/LIDAR array backpacks, etc.) to capture imagery along publicly accessible routes of various cities, towns, and other locations. To enhance the image quality, the images may have been captured during a consistent time window during the day (e.g., 9 a.m. to noon), a consistent season (e.g., spring or summer), and/or consistent weather conditions (e.g., bright, sunny or mostly sunny days) to ensure that the images had consistent lighting regardless of location. The imagery would then be processed to determine feature points well-localized in three dimensions and having corresponding feature vectors. As different users perform visual localization with their user devices, the service provider can receive new, noised feature vectors generated by a user device using the adversarially trained feature extraction model. These noised feature vectors may be associated with a property of the local environment at the time images were captured by the user device. For example, the visual localization may be performed during autumn, such that trees have lost their leaves. Because an image of a scene with trees in autumn (with no leaves) may produce different feature vectors for a feature point than an image of the same scene during the spring (with leaves), the new noised feature vectors can encode this new information. The service provider can then use the new feature vectors to augment the maintained feature information. For example, the new feature vectors can be added to the library of feature information and identified with the property (e.g., autumn season). Additional properties including time of day and weather conditions are possible.

As a fourth particular example, a user can perform visual localization using their user device. The user device can request feature information from a service provider that maintains feature information for a local environment. As part of the request, the user device can provide the service provider with additional location information, including time, weather conditions, date/season information, and the like. The user device can receive a set of feature vectors that both correspond to the local environment and have been selected (by the service provider) based on the location information. For example, the user may be performing visual localization in the evening, such that the image includes artificial lighting from buildings and streetlights as well as reduced sunlight. Based on the time of day, the service provider can provide the feature information for that geographic area that more closely corresponds with the time of day. This feature information may have been provided to the service provider by other user devices performing visual localization using the adversarially trained feature extraction model during a similar time of day, such that the service provider had augmented the maintained feature information to include both the original feature information obtained from images collected under consistent conditions (e.g., late morning on sunny days in the spring or summer by the service provider's deployed camera systems) and the new feature information obtained from crowdsourcing from various user devices.

The examples described herein provide a number of technical improvements to address a number of technical problem as compared to conventional systems and techniques. Storing and maintaining data and other information that can be used to recreate sensitive or identifiable elements requires additional security measures, including additional encryption, isolated storage, verification checks, and the like. These additional security measures can be computationally expensive when handling or processing the data, for example, when retrieving the data from storage (e.g., decrypting/encrypting) or transmitting it to user devices (e.g., authorization and/or verification of the user devices). By training the feature extraction model adversarially, the noised feature vectors generated by the feature extraction model and used by the service provider neither contain identifiable information nor can be used to reconstruct images with identifiable elements. Moreover, updating feature information using the noised feature vectors avoids transmitting new image data to the service provider, vastly reducing the storage requirements of the both the user devices and the service provider's server devices as well as the computational costs for sending/receiving the greater amount of image data versus feature information. The user devices realize improved battery life, reduced bandwidth usage, and memory conservation.

Additionally, by obtaining new feature information including the noised feature vectors from user devices, the service provider can update the feature information that it maintains. The updated feature information can more accurately represent the local environments, including accounting for changes over time. By using the updated feature information, the visual localization system can provide more accurate results, allowing user devices to complete a localization operation more quickly and efficiently and with fewer captured images, thereby conserving battery life of the user device and reducing the memory/storage costs associated with processing a greater number of images. The service provider's computer systems also realize a reduction in computational expenditures by obtaining the new feature information from user devices. The service provider can avoid deploying dedicated camera systems to a large number of cities and other locations to capture substantial amounts of new image data and process the new image data to determine updated feature information. Moreover, the multiple user devices can efficiently capture new images and generate corresponding feature information for the various local environment at different times of day, during different seasons, and during different weather conditions, providing the service provider with updated feature information associated with these conditions. The service provider can thereby avoid deploying the dedicated camera systems throughout the year and/or to the same location multiple times during a day to update the feature information, further reducing computation costs associated with the update process.

Although the examples described above make reference to visual localization with a user and a user device, it should be appreciated that other devices may perform visual localization using an adversarially trained feature extraction model. For example, robotic systems and other systems including, delivery drones, aerial drones, and the like relying on computer vision may make use of visual localization. These additional example systems can perform visual localization and produce the updated feature information that is usable by the service provider to update maintained feature information.

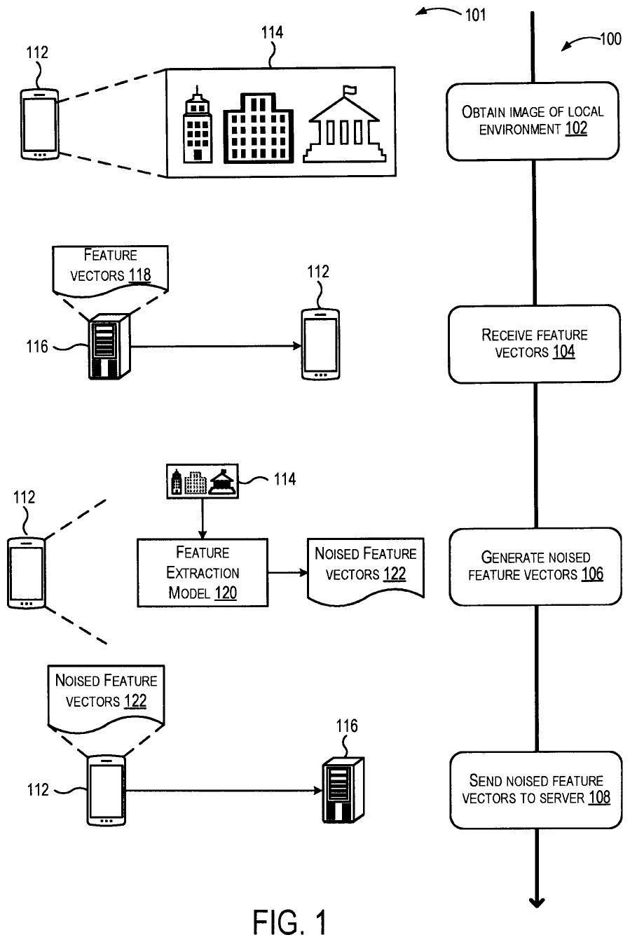

Turning now to the figures, FIG. 1 illustrates a simplified flow chart of an example process 100 and block diagram 101 of a technique to generate noised feature vectors 122 using a trained feature extraction model 120, according to some embodiments. The diagram 101 includes a user device 112 and a server device 116, which may be examples of computer devices that are configured to communicate over one or more networks to perform both visual localization and send and receive feature information. The user device 112 is illustrated as a smartphone. In some embodiments, the user device 112 can be any suitable user device including smartphone, tablet, smartwatch, wearable headset, or any other suitable device that is configured to capture images, for example via a built-in camera. In some examples, the user device 112 may include one or more applications, which may include custom-built algorithms and other logic, code, or executable instructions, to enable performance of at least some of the techniques described herein. The user device 112 may also include storage media for storing computer-executable instructions (e.g., that make up the application) and other data described herein, including images, feature information, feature vectors. The user device 112 may be operated by a user.

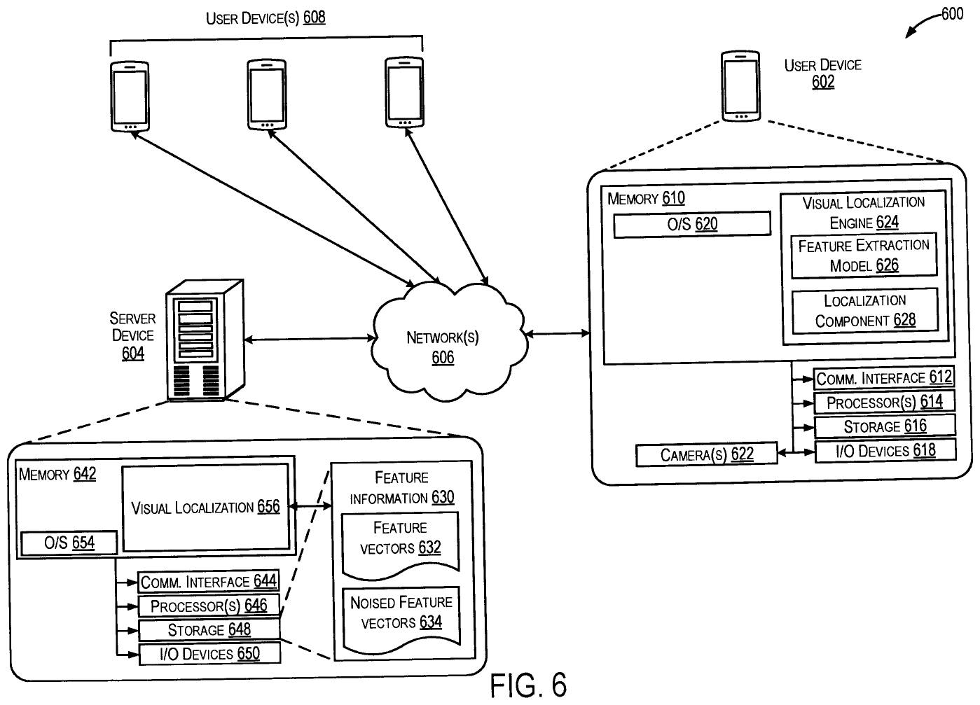

Similarly, the server device 116 may be any suitable computing device or arrangement of one or more computing devices that can be configured to perform the operations described herein and communicate with the user device 112 and other user devices for performing visual localization. In some embodiments, the server device 116 one or more virtual machines implemented within a cloud computing or other hosted environment. The cloud computing environment may include provisioned computing resources like computing, storage, and networking. For example, the server device 116 can include cloud-based computing with associated storage for maintaining feature information. Additional details about exemplary user devices and service provider computing systems like server device 116 are described below with respect to FIG. 6.

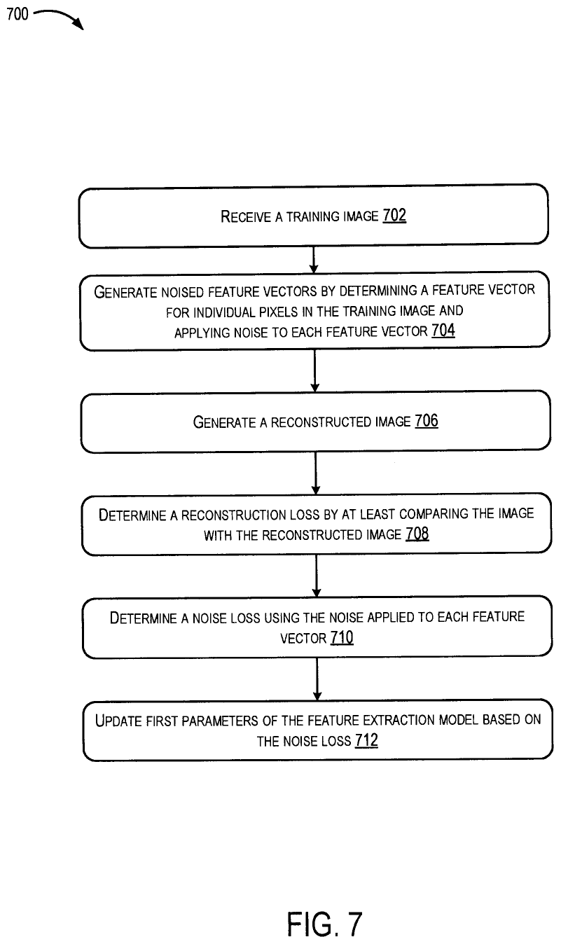

The process 100, and any other process described herein (e.g., processes 700, 800, 900, and 1000 of FIGS. 7-10, respectively) are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 100 can begin at block 102 with the user device 112 obtaining an image 114 of a local environment. The user device 112 can capture the image 114 using a camera, which in some examples is a built-in camera as found in many modern smartphones and tablet computers. The image 114 can represent of a view of the local environment. In many cases for visual localization, the local environment is a public streetscape in a city or town that includes multiple buildings and other objects that can provide usable feature points for the localization process. However, such examples are not intended to be limiting and other local environments like parks, public plazas, rural roads, and the like.

Generally, the local environments are publicly viewable and/or publicly accessible areas such that both the service provider managing the visual localization system and the users making use of the visual localization system can obtain the imagery necessary to perform the feature extraction and matching techniques needed for visual localization. As a particular example, the user device 112 may be a smartphone held by a user on a city sidewalk to capture image 114 of the adjacent street, building facades, and other objects viewable by the camera. The local environment may then represent that sidewalk, adjacent street, and additional cross-streets nearby. Thus, the image 114 can represent a view of the local environment from the pose of the camera. A different user device in the same local environment could capture a different image, which in some cases could have features that overlap with the image 114 (e.g., viewing the same buildings from a different angle) or have no overlap at all with image 114 (e.g., viewing an entirely different part of the neighborhood). The local environment can therefore be considered a larger geographic area that can be viewed from multiple perspectives and associated with numerous feature points and associated feature vectors maintained by the service provider.

At block 104, the user device 112 can receive feature vectors 118. The user device 112 can receive the feature vectors 118 from the server device 116 of the service provider maintaining the feature vectors 118 and other feature information corresponding to the local environment. The feature vectors 118 can correspond to points (“feature points”) in three-dimensional space within the local environment. For example, based on the initial image processing performed by the service provider on imagery of the local environment (e.g., captured via a vehicle, backpack, or other means with an on-board camera system moving through the local environment), a number of feature points can be identified within the imagery. Each feature point may be three-dimensional coordinates representing the position of the feature point in a coordinate system relative to the local environment. Each feature point may be associated with a feature vector determined from an image that includes a view of the feature point in the local environment (e.g., an image having a pixel that corresponds to the feature point). The feature vector can be a vector of values that encode the information of the feature point pixel and nearby pixels in images that contain the feature point. In some examples, the feature vector may be a 64-element vector (e.g., 64 numerical values). In other examples, the feature vector may be an N-element vector. The feature vector values are therefore an encoding of the “appearance” of the corresponding pixel with respect to other pixels in the image (and/or pixels in other images that also include the feature). Generally, the feature vectors 118 are extracted using a machine learning model (e.g., feature extraction model 120) and have no semantic interpretation (e.g., the values cannot be ascribed to a human-interpretable meaning).

The feature vectors 118 received from the server device 116 may correspond to the local environment in which the image 114 was captured. For example, the service provider may maintain feature information for several locations (e.g., cities, towns, etc.). The feature vectors 118 received by the user device 112 may be selected from a database of feature information for the several locations. The server device 116 can select the feature vectors 118 based on an indication of the general location of the user device 112 in the local environment. For example, the user device 112 can send location information (e.g., a GPS location of the user device) to the server device when requesting the feature vectors 118. Using the location information, the server device 116 can determine the geographic area for the local environment in which the user device 112 is when capturing the image 114 and send the feature vectors 118 that correspond to that geographic area. In this way, the server device 116 need only send a portion of the feature information that the server device 116 maintains to the user device 112.

At block 106, the user device 112 can input the image 114 into the feature extraction model 120 to generate noised feature vectors 122. The feature extraction model 120 may have been previously adversarially trained with a reconstruction model to identify feature points in an image and generate noised feature vectors for those feature points. The feature extraction model 120 may be a component of a visual localization engine or application executing on the user device 112. The noised feature vectors 122 may be matched with the feature vectors 118 to determine a pose of the camera of the user device 112. For example, the feature vectors 118 can correspond to a feature point having three-dimensional coordinates in a coordinate system for the local environment. When a feature vector of feature vectors 118 is matched with noised feature vectors 122, the coordinates of the feature point corresponding with the feature vector can be used to determine a projection for the feature point in the image 114 used to generate the noised feature vectors. Using multiple projections from multiple matched feature points, the pose of the camera that captured image 114 (e.g., the location and orientation of user device 112) can be triangulated. In some embodiments, the feature extraction model 120 may generate a noised feature vector for each pixel in the image 114 and a score for each noised feature vector. Based on the score, the visual localization engine can select the highest ranked noised feature vectors (e.g., the top 2,000 noised feature vectors) to use when matching with the feature vectors 118.

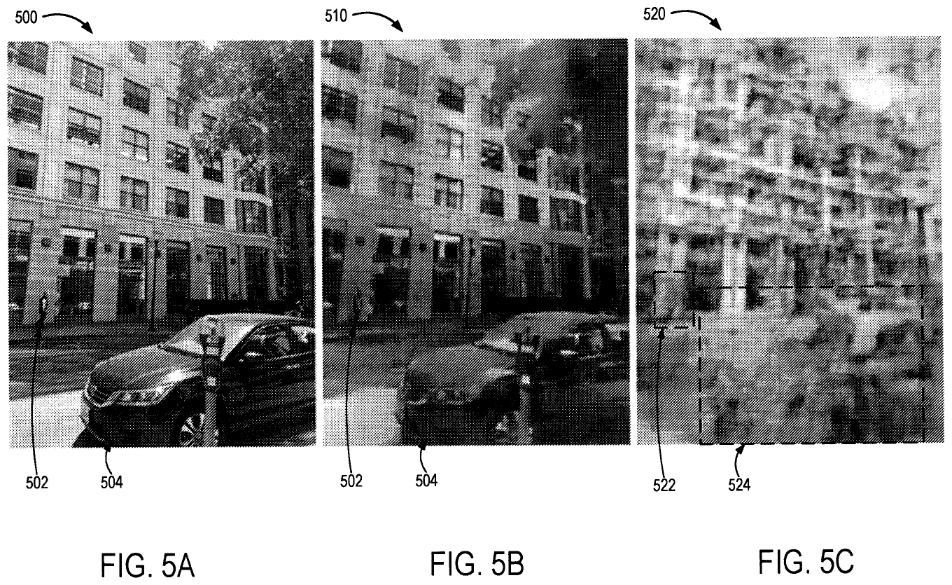

At block 108, the user device 112 can send the noised feature vectors 122 to the server device 116. As described previously, the noised feature vectors 122 do not contain any explicit image information from the image 114, nor are the noised feature vectors 122 suitable for use by a model trained to reconstruct images from feature vectors. Additional information about the effects of the noise in the noised feature vectors 122 may be found below with respect to FIGS. 5A-5C. In some embodiments, the user device 112 may send additional information to the server device, including an estimated location of the user device 112, a camera pose for the image, and/or three-dimensional coordinates of feature points corresponding to individual pixels of the image 114. The additional information may be used by the server device 116 to update the feature information maintained by the service provider, for example, by using the coordinates to update or refine the location of feature points or to add new feature points and corresponding noised feature vectors into the maintained feature information. In this way, the image 114 itself is not transmitted between the user device 112 and the server device 116, and the information that is transmitted cannot be used to reconstruct identifiable elements from the image 114.

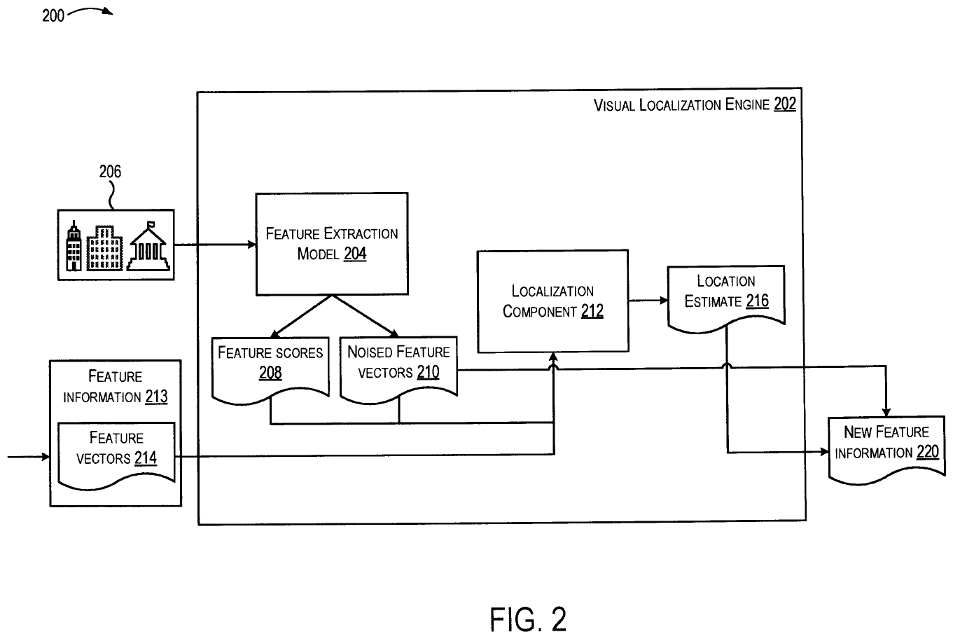

FIG. 2 illustrates an example architecture of a system 200 that includes a visual localization engine 202 that can execute a trained feature extraction model 204, according to some embodiments. The visual localization engine 202 can be a component of an application executing on a user device (e.g., user device 112 of FIG. 1). The visual localization engine 202 can include multiple components that may perform functions in accordance with at least one embodiment described herein.

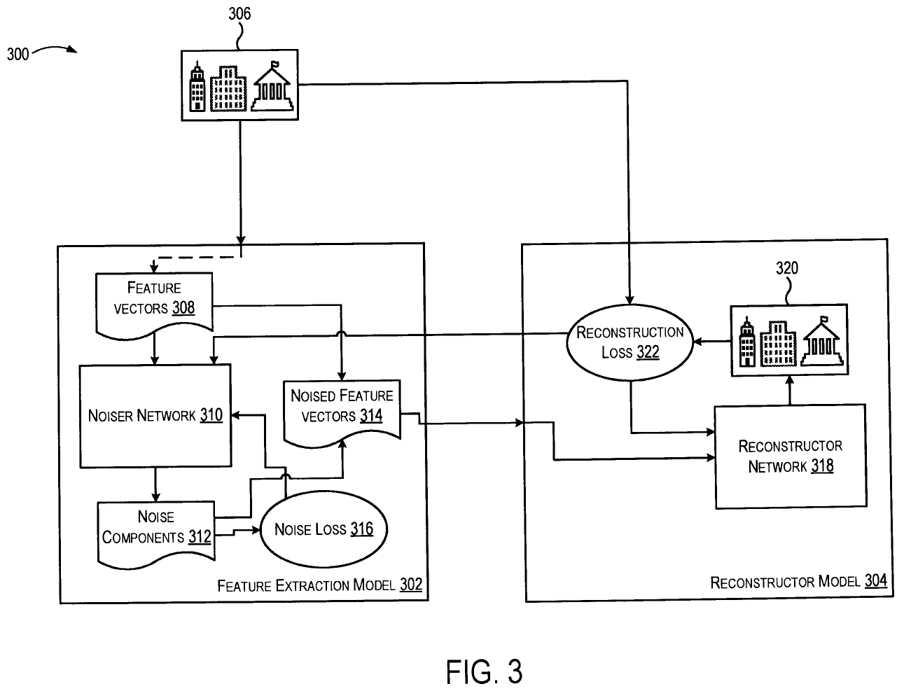

As illustrated, the visual localization engine 202 can include feature extraction model 204. The feature extraction model 204 can be configured to generate both feature scores 208 and noised feature vectors 210 using an image 206 as input. The feature extraction model 204 can be a machine learning model that includes one or more convolutional neural networks (CNNs). The CNNs within the feature extraction model 204 can have a plurality of parameters (e.g., weights) that characterize the network and that can be adjusted using training (e.g., supervised or unsupervised learning). The feature extraction model 204 can be trained adversarially with a reconstruction model that takes feature vectors as inputs and produces reconstructed images. As described above, the adversarial training can include alternatively training the feature extraction model 204 to both minimize a noise loss (e.g., a loss computed using a loss function for matching noised feature vectors with training feature vectors) and maximize a reconstruction loss (e.g., a similarity computed for a comparison of the input training images and the reconstructed images from the reconstruction model), and training the reconstruction model to minimize the reconstruction loss. Additional details of the adversarial training are provided below with respect to FIG. 3.

The image 206 may be an example of image 114 described above with respect to FIG. 1. The image 206 may be obtained via a camera, which may be a component of a user device hosting the visual localization engine 202. The image 206 may be a view of a streetscape or other scene within a local environment of the user device. The image 206 can be an input to the feature extraction model 204, which can generate noised feature vectors 210 for individual pixels in the image. The number of pixels in image 206 can vary, including, for example, 12 megapixels or 48 megapixels. In some embodiments, the feature extraction model 204 can generate noised feature vectors 210 for each pixel in the image 206. The feature extraction model 204 can also generate feature scores 208 that correspond to each of the noised feature vectors 210. For example, the feature extraction model 204 can determine a score that characterizes the reliability of the corresponding feature vector for matching with feature vectors 214 and other feature information 213 provided by a service provider.

The visual localization engine 202 can also include a localization component 212. The localization component 212 may be configured to perform the matching of the noised feature vectors 210 with the feature vectors 214 and the geometric triangulation of the camera system to determine a location estimate 216. The localization component 212 can use the feature scores 208 to select the highest ranked noised feature vectors 210 for use with matching with the feature vectors 214. For example, the localization component 212 can select the 2,000 noised feature vectors 210 having the highest feature scores 208. In some embodiments, the localization component 212 can select more than 2,000 noised feature vectors 210 or less than 2,000 noised feature vectors 210. To triangulate the pose of the camera, the localization component 212 can determine, by matching with the selected noised feature vectors 210, the feature vectors 214 that are represented in the image 206. The feature information 213 provided to the visual localization engine 202 can include position or coordinate information for each of the feature vectors 214. For example, each feature vector can be associated with a feature point having coordinates in a coordinate system for the local environment in which image 206 was captured. This coordinate system may have been previously defined by the service provider when creating the feature information 213. Using the coordinate information of the feature points for the matched feature vectors, the localization component 212 can determine a projection from pixel within image 206 corresponding to the feature point to an estimated location of the camera. By determining the intersection of multiple such projections, the localization component 212 can determine the pose of the camera to a high degree of accuracy. Since the camera can be integrated fixedly into the user device, the pose of the camera can be the location and orientation of the user device. The determined location of the user device can therefore be the location estimate 216.

The visual localization engine 202 can be configured to produce new feature information 220 to be sent to the service provider. The new feature information 220 can include the noised feature vectors 210 generated from the image 206 using feature extraction model 204. The new feature information 220 can also include the location estimate 216. In some embodiments, the new feature information 220 can also include the camera pose, three-dimensional coordinates for the feature points corresponding to the noised feature vectors 210, and the projections of the feature points into the camera pose. In some embodiments, the new feature information 220 can include a subset of the all the noised feature vectors 210 generated by the feature extraction model 204. For example, the feature extraction model 204 may generate noised feature vectors 210 for each individual pixel in the image 206, but only the noised feature vectors that successfully matched with feature vectors 214 may be included in the new feature information 220.

FIG. 3 illustrates an example flow 300 for adversarially training a feature extraction model 302, according to some embodiments. Training the feature extraction model 302 can be performed by a computing system of a service provider, including one or more server devices (e.g., server device 116 of FIG. 1). Training the feature extraction model 302 can be done prior to deploying the trained feature extraction model to user devices for use in visual localization. The feature extraction model 302 may be an example of feature extraction model 204 described above with respect to FIG. 2. The flow 300 is illustrated with arrows indicating a general flow of data or information between components; however, no single process or operation is intended to be conveyed by these arrows.

As described briefly above, adversarial training can include training of two separate models to produce respective outputs while competitively attempting to minimize/maximize a loss function. In particular, the feature extraction model 302 can be adversarially trained with a reconstructor model 304. The feature extraction model 302 can include one or more neural networks (not shown) to produce feature vectors from input training images 306. The input training images 306 may include images similar to images that would be expected to be captured during visual localization. For example, the input training images can include elements that can be categorized as identifiable, corresponding to people, faces, vehicles, and other objects that may be found in images for which accurate reconstruction is not desirable. The one or more neural networks can each include layers characterized by parameters that can be tuned during each training step. Tuning the parameters can be done so as to optimize the results of a loss function.

The feature extraction model 302 can also include a noiser network 310. The noiser network 310 may be a neural network (e.g., CNN). In some embodiments, the noiser network 310 can be additional layer of the one or more neural networks that generate the feature vectors 308. In other embodiments, the noiser network 310 may be merged with the one or more neural networks that generate the feature vectors, so that the noise components 312 are not generated separately from the feature vectors 308 but instead noised feature vectors 314 are output directly from the one or more neural networks. The noiser network 310 can determine noise components (e.g., a perturbation to be applied to each element of feature vectors 308). For example, each feature vector of feature vectors 308 may be a 64-element vector. The noiser network 310 can determine a corresponding 64-element vector of noise components 312 to be added to each of the 64-elements of a feature vector. Each feature vector 308 may have different noise components 312. As with the one or more neural networks, the noiser network 310 may be characterized by parameters that can be adjusted or tuned during the training process. The noise components 312 can be combined with the feature vectors 308 to produce noised feature vectors 314. Additionally, the feature extraction model 302 can compute a noise loss 316. The noise loss 316 may be a value computed from a loss function that takes the noise components 312 and/or the noised feature vectors 314 and determines how closely the noised feature vectors 314 match training feature vectors associated with the input training images 306. The noise loss function can include triplet loss, regularization loss, or other suitable loss function. Training the feature extraction model 302 can include modifying the parameters of the neural networks, including the noiser network 310, to reduce the noise loss 316 to a minimum level.

In contention with the feature extraction model 302, the reconstructor model 304 can be trained to generate reconstructed images 320 using feature vectors generated as the output of a feature extraction model 302. The reconstructor model 304 can include a reconstructor network 318, which can be a neural network (or more than one neural network) characterized by tunable parameters that can be adjusted during training. The training of the reconstructor model 304 can optimize a reconstruction loss 322. The reconstruction loss 322 may be a value computed with a loss function that compares the reconstructed image 320 and the input training image 306. Because the input training image 306 (as well as captured images during visual localization) can include identifiable elements, a well-reconstructed image 320 will also include similar identifiable elements (or regions of the images containing reconstructed approximations of those elements). For example, if the input training image includes a person, the reconstructed image can also include an approximate image of the same person to the accuracy of the reconstructor model 304. However, using noised feature vectors (e.g., noised feature vectors 314) as input, the reconstructed image from the reconstructor model may obfuscate the identifiable elements (or the regions containing the elements) to render them unidentifiable. As described herein, training the reconstructor model 304 can include modifying the parameters of the reconstructor network 318 to reduce the reconstruction loss 322 to a minimum level.

To train the feature extraction model 302 and the reconstructor model 304 adversarially, each model is trained alternately using the same input training image 306. The parameters of the feature extraction model 302 are adjusted to minimize the noise loss 316. The noised feature vectors 314 output from the feature extraction model 302 are input into the reconstructor model 304 to produce a reconstructed image. The parameters of the reconstructor model 304 are then adjusted to minimize the reconstruction loss 322. The reconstruction loss 322 is then provided back to the feature extraction model 302. The parameters of the feature extraction model 302 are further updated to maximize the reconstruction loss 322. This alternate training continues until the parameters of both models are suitably adjusted achieve minimal noise loss 316 and optimal reconstruction loss 322 (i.e., either minimal or maximal based on the competing training of the respective models).

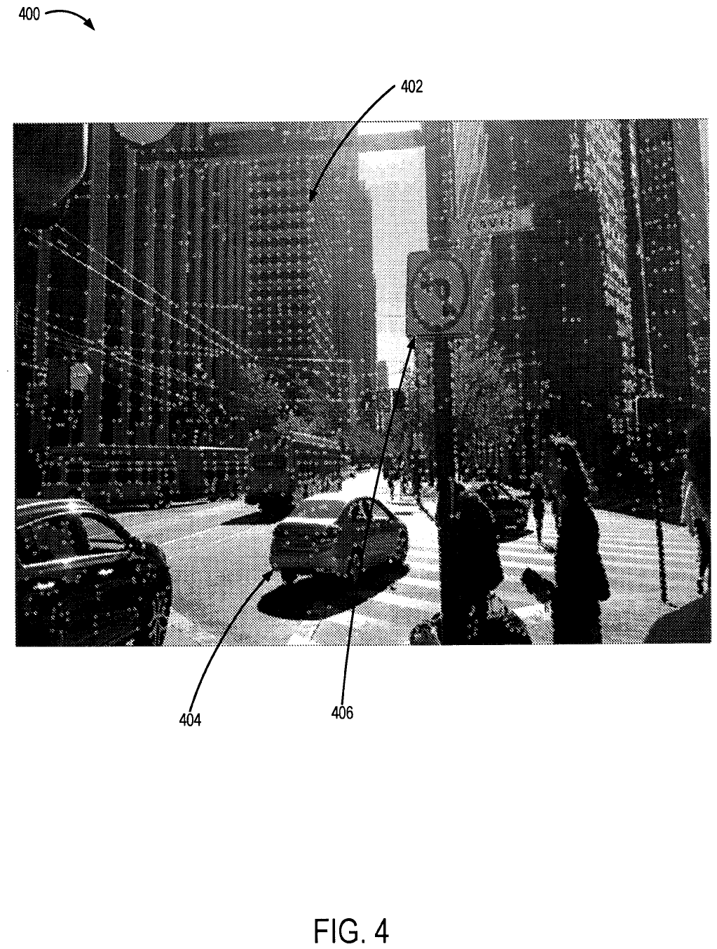

FIG. 4 illustrates an example image 400 with identified feature points, according to some embodiments. The image 400 depicts a typical city streetscape, including multiple buildings, street signs, several vehicles, and several pedestrians. The image 400 may be input into a feature extraction model (e.g., feature extraction model 204 of FIG. 2), which can generate feature vectors and corresponding feature scores for individual pixels in the image 400. The pixels with the highest feature scores are represented in the image 400 with the light-colored circles, corresponding to feature points that are likely to match with feature vectors maintained by a service provider maintaining feature information for a visual localization system.

As illustrated in FIG. 4, the feature points identified in image 400 tend to correspond to points in the image 400 having high image gradients with respect to nearby pixels and can be found along “edge-like” or “corner-like” elements of the image 400. Particular feature points of note in image 400 include feature point 402 at a corner of a background building, feature point 404 at the edge of the rear of a moving vehicle, and feature point 406 on the edge of street sign imagery. As described in several examples herein, feature points on transient objects like cars and people as well as objects that may change over time like signs and trees may not match well if at all with the feature information maintained by the service provider. For example, the feature point 404 is unlikely to match any stored feature information from the service provider when performing visual localization, because the images used to generate the feature information is unlikely to contain the same or even a similar vehicle in the same location as in image 400. By contrast, feature point 402 is likely to match stored feature information because the building likely appears in most imagery captured for the local environment of image 400 when generating the feature information. Similarly, feature point 406 will also likely match because the street sign appears in the imagery used to create the stored feature information, although the street sign may be changed or moved over time.

FIG. 5A illustrates an example image 500 with identifiable elements, according to an embodiment. The image 500 can represent a typical image captured by a user device (e.g., user device 112 of FIG. 1) to perform visual localization. As shown in FIG. 5A, image 500 can include a view of a streetscape with a building façade, a portion of a tree, a pedestrian 502, and a car 504. Of these elements, the pedestrian 502 and the car 504 may be considered “identifiable,” such that obfuscating these elements is desirable in a reconstructed image to prevent the recreation of a face, a license plate, or other personally identifiable or privacy-sensitive imagery.

FIG. 5B illustrates an example reconstructed image 510 using feature vectors and including identifiable elements, according to an embodiment. The reconstructed image 510 may be generated by a reconstructor model trained to generate an image using feature vectors as inputs. The feature vectors can be generated from a feature extraction model using the image 500 as an input. These feature vectors do not have noise added to the feature vector components. The reconstructor network can take these un-noised feature vectors as input and generate reconstructed image 510 as an output. As shown in FIG. 5B, the reconstructor model can produce a relatively accurate reconstructed image 510 in which the pedestrian 502 and car 504 are recognizable.

FIG. 5C illustrates another example reconstructed image 520 using noised feature vectors and including obfuscated elements, according to an embodiment. The reconstructed image 520 may be generated by the same reconstructor model that generated reconstructed image 510. The noised feature vectors can be generated by an adversarially trained feature extraction model (e.g., feature extraction model 302 of FIG. 3) using the image 500 as input. The reconstructor model can take the noised feature vectors as input. As shown in FIG. 5C, the reconstructor model has difficulty reproducing identifiable elements. For example, obfuscated region 522 corresponds to the pedestrian 502 and shows only a vague outline that could be interpreted as a pedestrian. Similarly, obfuscated region 524 corresponds to the car 504 and shows a highly blurred region that is unlikely to be identified as a car. Importantly, the noised feature vector used to generate the reconstructed image 520 are still suitable to match with feature information stored by a visual localization service provider to perform visual localization.

FIG. 6 illustrates an example architecture of a system 600 that can implement techniques for visual localization using noised feature vectors, according to some embodiments. The system 600 includes a user device 602 (e.g., a mobile device, a smart phone, or other suitable computing device), a server device 604, additional user device(s) 608, and one or more network(s) 606. The server device 604 may be an example of server device 116 of FIG. 1. The server device can be one or more remote computing devices, including cloud devices. Each of these elements depicted in FIG. 6 may be similar to one or more elements depicted in other figures described herein. In some embodiments, at least some elements of system 600 may be used to perform visual localization in one or more local environments of a city, town, or other location. The network(s) 606 may include any one or a combination of many different types of networks, such as cable networks, the Internet, wireless networks, cellular networks, and other private and/or public networks.

As described herein, the user device 602 can have at least one memory 610, a communications interface 612, one or more processing units (or processor(s)) 614, a storage 616, one or more camera(s) 622, and one or more input/output (“I/O”) device(s) 618. The processor(s) 614 may be implemented as appropriate in hardware, computer-executable instructions, firmware or combinations thereof. Computer-executable instruction or firmware implementations of the processor(s) 614 may include computer-executable or machine executable instructions written in any suitable programming language to perform the various functions described. The I/O device(s) 618 can include displays, monitors, touch screens, mouse, keyboard, or other I/O device. The one or more camera(s) 622 can include an imaging system configured to capture images using the user device 602.

The memory 610 may store program instructions that are loadable and executable on the processor(s) 614, as well as data generated during the execution of these programs, including image data, feature vectors, and other feature information. Depending on the configuration and type of user device 602, the memory 610 may be volatile (such as random access memory (“RAM”)) or non-volatile (such as read-only memory (“ROM”), flash memory, etc.). In some implementations, the memory 610 may include multiple different types of memory, such as static random access memory (“SRAM”), dynamic random access memory (“DRAM”) or ROM. The user device 602 may also include additional storage 616, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some embodiments, the storage 616 may be utilized to store data contents received from one or more other devices (e.g., server device 604). For example, the storage 616 may store received feature information usable for visual localization.

The memory 610 may include an operating system (O/S) 620 and one or more application programs, software components, or services for implementing the features disclosed herein, including a visual localization engine 624. The visual localization engine 624 may be configured to execute a feature extraction model 626 that has been trained to output noised feature vectors (e.g., noised feature vectors 122 of FIG. 1). The visual localization engine 624 may also be configured to identify feature points and corresponding noised feature vectors and perform matching to determine a location and orientation of the user device 602 using a localization component (e.g., localization component 212 of FIG. 2). The visual localization engine 624 can send the location, orientation, and noised feature vectors to the server device 604 (e.g., via communications interface 612).

The user device 602 may also contain a communications interface 612 that allows the user device 602 to communicate with a stored database, another computing device or server, additional user device(s) 608, or other devices on the network(s) 606. The user device 602 may also include I/O device(s) 618, such as for enabling connection with a keyboard, a mouse, a pen, a voice input device, a touch input device, a display, speakers, a printer, etc.

Turning now to server device 604 in more detail, the server device 604 can be any suitable type of computing system including, but not limited to, a laptop computer, a desktop computer, a mobile phone, a smartphone, a server computer, etc. In some embodiments, the server device 604 is executed by one or more virtual machines implemented within a cloud computing or other hosted environment. The cloud computing environment may include provisioned computing resources like computing, storage, and networking. The server device 604 can communicate with the user device 602 via the network(s) 606 or other network connections. The server device 604 may be configured to implement the functionality described herein as part of a distributed computing environment.

The server device 604 can include a memory 642, one or more processor(s) 646, I/O devices 650, and at least one storage unit 648. As with the processor(s) 614 of user device 602, the processor(s) 646 may be implemented as appropriate in hardware, computer-executable instructions, software, firmware, or combinations thereof. Computer-executable instruction, software, or firmware implementations of the processor(s) 646 may include computer-executable or machine-executable instructions written in any suitable programming language to perform the various functions described. The memory 642 may store program instructions that are loadable and executable on the processor(s) 646, as well as data generated during the execution of these programs. Depending on the configuration and type of memory included in the server device 604, the memory 642 may be volatile (such as RAM) and/or non-volatile (such as read-only memory (“ROM”), flash memory, or other memory). In some embodiments, the storage 648 may include one or more databases, data structures, data stores, or the like for storing and/or retaining information associated with the server device 604 or the user device 602. The storage 648 may include data stores for storing feature information, including feature points, coordinate information of feature points, corresponding feature vectors, and new feature information including noised feature vectors produced by the user device 602 and/or additional user device(s) 608.

The memory 642 may include an operating system (O/S) 654 and one or more application programs, modules, or services for implementing the features disclosed herein, including visual localization component 656. The visual localization component 656 may be configured to send feature information (e.g., a portion of feature information 630) to the user device 602 in response to requests from the user device 602. The visual localization component 656 can select a portion of the feature information based on a location indication or location information (e.g., a GPS position) of the user device 602. For example, feature information 630 may be maintained in storage 648 of the server device 604 and correspond to several geographic areas for various cities in which visual localization can be performed. The visual localization component 656 can use the location information to select feature vectors 632 corresponding to the geographic area that includes the location of the user device 602. In some embodiments, the storage 648 may include one or more databases, data structures, data stores, or the like for storing and/or retaining information associated with the server device 604 or the user device 602. The storage 648 may include data stores for storing the feature information 630, including feature vectors 632 and noised feature vectors 634 obtained from the user device 602 and additional user device(s) 608.

The visual localization component 656 may also be configured to receive new feature information including noised feature vectors generated by the visual localization engine 624. The visual localization component 656 can augment the feature information 630 with the new feature information received from the user device 602. In some embodiments, the server device 604 can receive indications of a property characterizing the image used for visual localization. Based on the indication, the visual localization component 656 can select a portion of the feature information 630 that includes noised feature vectors 634 as well as feature vectors 632.

As with the user device 602, the server device 604 may contain a communications interface 644 that allows the server device 604 to communicate with user device 602, a stored database, another computing device or server, or additional user device(s) 608. The server device 604 may also include I/O device(s) 650, such as for enabling connection with a keyboard, a mouse, a pen, a voice input device, a touch input device, a display, speakers, a printer, etc.

FIG. 7 illustrates an example process 700 for training a feature extraction model, according to some embodiments. The process 700 may be performed by one or more components of a computing system of a service provider, including one or more server devices (e.g., server device 116 of FIG. 1, server device 604 of FIG. 6). Some of the operations described with respect to process 700 may be similar to operations described above with respect to flow 300 of FIG. 3.

Process 700 may begin at block 702, when a computing system receives a training image. The training image may include elements similar to images expected to be obtained by devices performing visual localization. For example, the training images can include buildings, cars, pedestrians, signs, and other elements of a streetscape that could be imaged using a camera. The training image can include identifiable elements, including faces, license plates, vehicles, and the like. The training image may be stored in a database of other training images accessible by the computing system.

At block 704, the computing system can use a feature extraction model (e.g., feature extraction model 302 of FIG. 3) to generate noised feature vectors. The feature extraction model can be characterized by first parameters. For example, the feature extraction model can include one or more neural networks that have parameters (e.g., weights) that characterize the layers of the neural networks. To generate the noised feature vectors, the computing system can use the feature extraction model to determine a feature vector for individual pixels in the training image and apply noise to each feature vector. In some embodiments, a feature vector can be determined for each pixel in the image. In some embodiments, the feature vector can include a plurality of feature values (e.g., 64 values for a 64-element vector) that encode information associated with the corresponding pixel. Applying the noise to each feature vector can then include perturbing one or more of the plurality of feature values. In some embodiments, the feature extraction model can include a noiser network characterized by at least one of the first parameters.

At block 706, the computing system can use a reconstructor model (e.g., reconstructor model 304 of FIG. 3) to generate a reconstructed image. The reconstructor model may be characterized by second parameters. For example, the reconstructor model can include one or more neural networks that have parameters (e.g., weights) for one or more of the layers of the neural networks. The reconstructor model can take feature vectors, including noised feature vectors, as inputs to generate the reconstructed image. In some embodiments, the reconstructed image can include an obfuscated element corresponding to an identifiable element in the training image.

At block 708, the computing system can determine a reconstruction loss by comparing the reconstructed image and the training image. The reconstruction loss can be determined using a loss function that can compute a similarity measure between the two images.

At block 710, the computing system can determine a noise loss using the noise applied to each feature vector. The noise loss can be computed using a loss function that takes the noise, the noised feature vectors, and training feature vectors as inputs. The noise loss can represent how well the noised feature vectors match the training feature vectors.

At block 712, the computer system can update the first parameters based on the noise loss. Updating the first parameters can result in a trained feature extraction model. In some embodiments, the first parameters are updated to minimize the noise loss. In some embodiments, the first parameters are updated to maximize the reconstruction loss.

In some embodiments, the second parameters of the reconstructor model can be updated based on the reconstruction loss. For example, updating the second parameters can train the reconstructor model to optimize the reconstruction loss. In some embodiments, the second parameters can be updated to minimize the reconstruction loss.

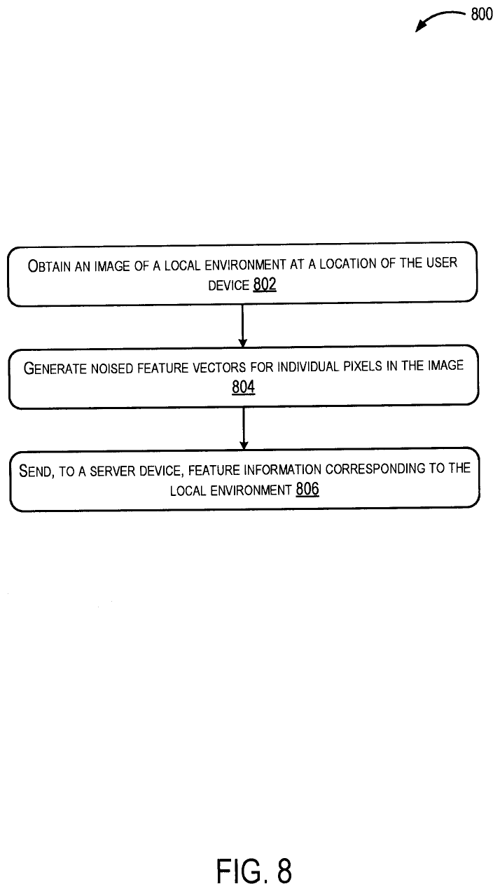

FIG. 8 illustrates an example process 800 for generating noised feature vectors for new images captured at a location, according to some embodiments. The process 800 may be performed by a user device, for example, user device 112 of FIG. 1 or user device 602 of FIG. 6.

Process 800 may begin at block 802 with the user device obtaining an image of a local environment at a location of the user device. The local environment may be a city street and can include views of buildings, pedestrians, signs, vehicles, and the like. The location may be the position of the user device at the time when the image is captured. The image may be obtained by a camera connected to or integrated with the user device. For example, the user device may be a smartphone with an integral camera system capable of capturing images (or streams of images, video, etc.) that can be processed by the user device.

At block 804, the user device can generate noised feature vectors for individual pixels in the image. The user device may execute a feature extraction model (e.g., feature extraction model 204 of FIG. 2) that has been adversarially trained with a reconstructor model to generate the noised feature vectors. The feature extraction model may be a component of a visual localization engine (e.g., visual localization engine 202 of FIG. 2) executing on the phone, for example, as an application or part of an application. The noised feature vectors can include descriptor information for the individual pixels. The noised feature vectors can also include noise components. For example, each noised feature vector can be a vector of values (e.g., N-element vectors) encoding a relationship between an individual pixel and surrounding pixels in the image (e.g., the “appearance” of the corresponding pixel in the image with respect to neighboring pixels). The values in the vector may each be perturbed by a small noise value. In some embodiments, the noised feature vectors are N-element vectors characterizing a. The reconstructor model (e.g., reconstructor model 304 of FIG. 3) can be a model trained to reconstruct images using feature vectors as input. When adversarially trained with the feature extraction model, the reconstructor model's parameters are adjusted to maximize a reconstruction loss computed by comparing training images and reconstructed images, while the feature extraction model's parameters are adjusted to (i) maximize the reconstruction loss and (ii) minimize a noise loss computed based on noise added to feature vectors generated using the training images.

At block 806, the user device can send feature information to a server device (e.g., server device 604 of FIG. 6). The server device may be a computing device or computing system of a service provider that provides visual localization services and maintains a database of feature information for various locations. The feature information sent by the user device can include a subset of the noised feature vectors generated by the feature extraction model. For example, the feature extraction model may generate a noised feature vector for each pixel in the image, but use only a small number of these noised feature vectors to match with feature vectors provided by the service provider during visual localization. The user device may then only send the noised feature vectors successfully matched during visual localization to the server device. In some embodiments, the feature information sent to the server device can also include an estimated location of the user device, a camera pose for the image, or three-dimensional coordinates of feature points corresponding to the individual pixels.

In some embodiments, the user device can receive feature vectors associated with the location of the user device. The received feature vectors may be sent to the user device from a server device in response to a request from the user device during visual localization. The user device can then estimate a location of the user device by matching at least one of the noised feature vectors with at least one of the feature vectors received from the server device. Matching the noised feature vectors with a feature vector can include computing a similarity value (e.g., a cosine similarity) using the two vectors.

In some embodiments, the user device can also use the feature extraction model to compute a corresponding feature score for each noised feature vector. The feature score can represent a confidence value for the noised feature vector's usefulness when matching feature vectors provided by the service provider. For example, the feature score can indicate which pixels/noised feature vectors correspond to the “best” feature points in the image. The user device can then use the feature score to select the subset of the noised feature vectors having the highest feature score to be sent to the server device. For example, the 2,000 noised feature vectors with the highest feature score may be selected to use for matching with feature vectors during visual localization and then sent to the server device.

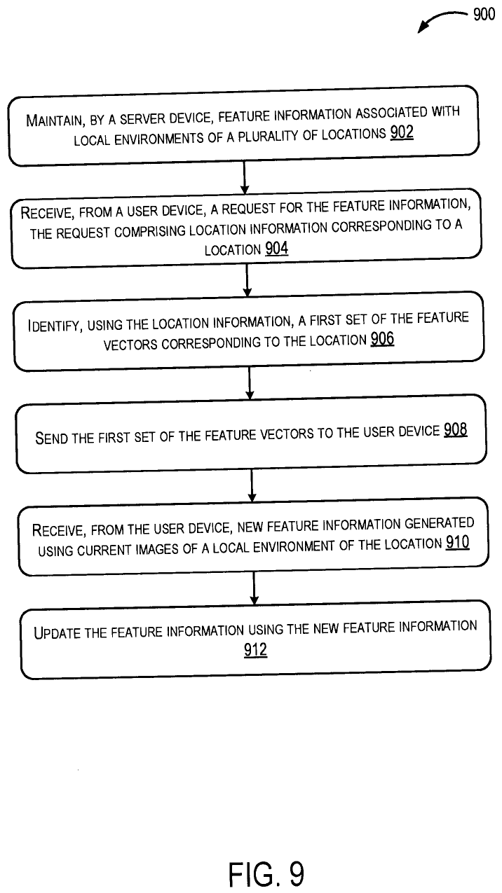

FIG. 9 illustrates an example process 900 for updating feature information for a location using noised feature vectors generated by user devices, according to some embodiments. The process 900 may be performed by one or more components of a computing system of a service provider, including one or more server devices (e.g., server device 116 of FIG. 1, server device 604 of FIG. 6).

Process 900 may begin at block 902 with the server device maintaining feature information associated with local environments of a plurality of locations. Maintaining the feature information can include storing the feature information in a database, data store, or other storage system accessible by the server device. The feature information can include feature vectors that were generated using images of the local environments. For example, the service provider may have captured and processed imagery for a large number of local environments in various cities, determined accurate locations and/or coordinates for feature points in the local environments, and prepared a database of the resulting feature information for use with visual localization. The feature information maintained by the server device can be characterized by a first property. For example, all of the imagery used to generate the feature information may have been captured in a consistent time window (e.g., 9 a.m. to noon local time), during a consistent season (e.g., spring or summer), or during a consistent weather condition (e.g., a sunny day). The time, date, season, and/or weather condition may be the first property characterizing the feature information.

At block 904, the server device can receive a request for the feature information from a user device. For example, a user can be performing visual localization with the user device and requires feature information corresponding to the local environment to match with (noised) feature vectors generated by the user device. The request can include location information corresponding to a location. The location can be the current location of the user device. The location information may be an approximate location of the user device, for example, provided by a GPS indication at the user device.

In response to the request, the server device can identify a first set of the feature vectors corresponding to the location, at block 906. The server device can use the location information to identify a geographic area in which the user device is currently located. Because the maintained feature information may be stored according to relatively large geographic areas, determining the corresponding geographic area allows the server device to select only the portion of feature vectors that are “close” to the user device and therefore matchable with noised feature vectors generated with the user device. At block 908, the server device can send the first set of the feature vectors to the user device.

At block 910, the server device can receive new feature information from the user device. The new feature information can be generated using current images of the local environment. For example, the user device can capture images of the local environment to perform visual localization. As a result, the user device can generate noised feature vectors to match with the first set of feature vectors sent by the server device. In some embodiments, the new feature information is generated by the user device using a trained feature extraction model (e.g., feature extraction model 204 of FIG. 2). In some embodiments, the new feature information includes a set of noised feature vectors. The new feature information can be characterized by a second property different from the first property. For example, the user device may be capturing images at a different time of day (e.g., early evening), during a different season (e.g., autumn or winter), or during different weather conditions (e.g., a cloudy day, a day with precipitation, etc.).

At block 912, the server device can update the feature information using the new feature information. Updating the feature information can include updating the positions/coordinates of feature points in the database of feature information and adding the noised feature vectors to the databased. For example, for an existing feature point in the feature information database, a single feature vector may be stored that was originally generated by the service provider's initial processing of imagery for the location. When receiving the new feature information, the noised feature vector corresponding to the same existing feature point can be added to the database associated with the existing feature point. In this way, the feature information can now include, for the feature point, one feature vector associated with the first property (e.g., images taken in the late morning of clear summer days) and a second, noised feature vector associated with the second property (e.g., images taken in the early evening on an overcast day in the autumn).

As more and more users perform visual localization in the same local environment, additional new feature information can be acquired by the server device and included into the feature information maintained by the service provider for visual localization. In some embodiments, a second user device can request the feature information. The second user device can be at a location in the same local environment as the user device. The request can include an identifier or other indication associated with the second property. For example, the second user device may be performing visual localization using images captured in the early evening. In response, the server device can identify a second set of feature vectors to send to the second user device. In particular, the server device can select a noised feature vector generated by the first user device and used to update the feature information. The server device can select the noised feature vector based on the identifier that indicates that feature vectors or noised feature vectors associated with the second property may provide better matching, and therefore better visual localization, than other feature vectors in the database of feature information. The second user device can also generate additional feature information that includes noised feature vector while performing visual localization. The additional feature information can likewise be sent to the server device. The server device can update the feature information using the additional feature information from the second user device, thereby obtaining up-to-date feature information as crowdsourced from multiple user devices.

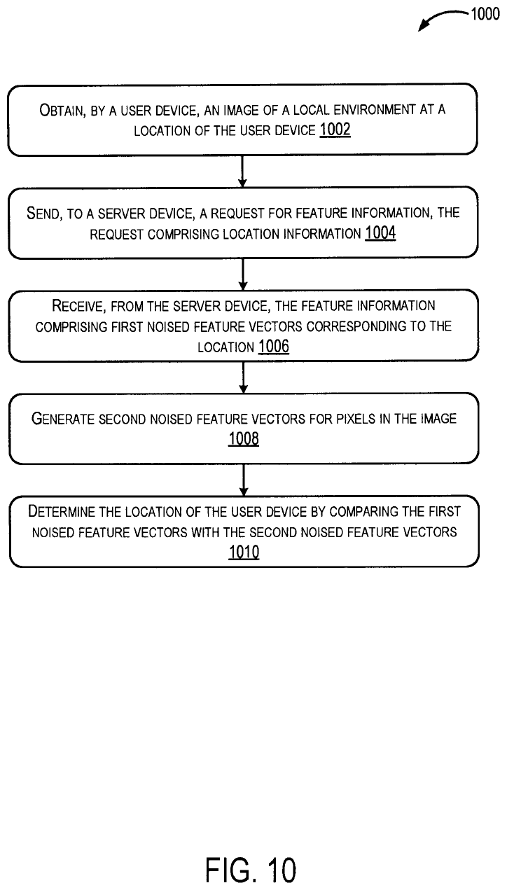

FIG. 10 illustrates an example process 1000 for selecting feature information for use in visual localization based a property of the feature information, according to some embodiments. The process 1000 may be performed by a user device, for example, user device 112 of FIG. 1 or user device 602 of FIG. 6.

Process 1000 may begin at block 1002 with the user device obtaining an image of a local environment at a location of the user device. The operations of block 1002 are similar to the operations of block 802 described above with respect to FIG. 8.

At block 1004, the user device can send a request for feature information to a server device. The request can include location information for the user device. At block 1006, the user device can receive feature information from the server device. The feature information can include first noised feature vectors for the local environment that includes the location. The operations of block 1004 and block 1006 are similar to the operations of blocks 904 and 906, respectively, described above with respect to FIG. 9, but from the perspective of the user device. In particular, the feature information received in block 1006 can include noised feature vectors from the server device, where the noised feature vectors have been added to the feature information database by the server device based on visual localization operations performed by a different user device. In some embodiments, obtaining the image of the local environment can occur at a first time and the first noised feature vectors are generated from a second user device using a second image of the local environment at a second time prior to the first time.

In some embodiments, the request can include environment information associated with the image of the local environment. For example, the request can indicate a weather condition or lighting condition of the image. The first noised feature vectors received by the user device can be characterized by a property associated with the environment information. For example, the first noised feature vectors can be characterized by being generated from images captured in the early evening as indicated by a lighting condition. In some embodiments, the environment information can include a time of day during which the image was obtained, a weather condition of the local environment when the image was obtained, or a season during which the image was obtained.

At block 1008, the user device can generate second noised feature vectors for pixels in the image. The user device can use a feature extraction model that takes the image as input to generate the second noised feature vectors. The feature extraction model can be adversarially trained with a reconstructor model.

At block 1010, the user device can determine its location by comparing the first noised feature vectors with the second noised feature vectors. For example, the user device can use the coordinates of the feature point corresponding with the first noised feature vectors to determine a projection for the feature point in the image used to generate the second noised feature vectors. Using multiple projections from multiple matched feature points, the pose of the camera that captured image (e.g., the location and orientation of user device) can be triangulated and used as the estimate of the location of the user device. In this way, the user device can perform visual localization by matching newly generated noised feature vectors with noised feature vectors maintained by the service provider.

In some embodiments, the user device can send feature information to the server device. The feature information can include a subset of the second noised feature vectors. The feature information can also include three-dimensional coordinates of feature points associated with the subset of the second noised feature vectors, a camera pose associated with the image, or projection information characterizing a relationship between the three-dimensional coordinates and the camera pose.

In some embodiments, the feature extraction model can be adversarially trained with the reconstructor model to (i) maximize a reconstruction loss computed by comparing training images and reconstructed images and (ii) minimize a noise loss computed based on noise added to feature vectors generated using the training images.

Illustrative methods and systems for managing user device connections are described above. Some or all of these systems and methods may, but need not, be implemented at least partially by architectures such as those shown at least in FIGS. 1-10. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C #or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
receiving a training image;
generating, using a feature extraction model characterized by first parameters and taking the training image as input, noised feature vectors by:
determining a feature vector for individual pixels in the training image; and
applying noise to each feature vector to produce the noised feature vectors;
generating, using a reconstructor model taking the noised feature vectors as input, a reconstructed image, the reconstructor model characterized by second parameters;
determining a reconstruction loss by at least comparing the training image with the reconstructed image;
determining a noise loss using the noise applied to each feature vector, the noise characterized by the reconstruction loss; and
updating the first parameters based on the noise loss.

2. The method of claim 1, wherein updating the first parameters comprises updating the first parameters to minimize the noise loss.

3. The method of claim 1, further comprising updating the second parameters based on the reconstruction loss.

4. The method of claim 3, wherein updating the second parameters comprises updating the second parameters to minimize the reconstruction loss.

5. The method of claim 1, wherein the feature extraction model comprises a noiser network characterized by at least one of the of the first parameters.

6. The method of claim 1, wherein the training image comprises an identifiable element.

7. The method of claim 6, wherein the reconstructed image comprises an obfuscated element corresponding to the identifiable element of the training image.

8. The method of claim 1, wherein determining a reconstruction loss comprises computing a similarity measure between the training image and the reconstructed image.

9. The method of claim 1, wherein the feature vector comprises a plurality of feature values encoding information associated with the pixel corresponding to the feature vector, and wherein applying the noise to each feature vector comprises perturbing one or more of the plurality of feature values.

2. A system, comprising:
one or more processors; and
one or more memories storing computer-executable instructions that, when executed by the one or more processors, cause the system to at least:
receive a training image;
generate, using a feature extraction model characterized by first parameters and taking the training image as input, noised feature vectors by:
determining a feature vector for individual pixels in the training image; and
applying noise to each feature vector to produce the noised feature vectors;
generate, using a reconstructor model taking the noised feature vectors as input, a reconstructed image, the reconstructor model characterized by second parameters;
determine a reconstruction loss by at least comparing the training image with the reconstructed image;
determine a noise loss using the noise applied to each feature vector, the noise characterized by the reconstruction loss; and
update the first parameters based on the noise loss.

11. The system of claim 10, wherein updating the first parameters comprises updating the first parameters to minimize the noise loss.

12. The system of claim 10, further comprising updating the second parameters based on the reconstruction loss.

13. The system of claim 12, wherein updating the second parameters comprises updating the second parameters to minimize the reconstruction loss.

14. The system of claim 10, wherein determining a reconstruction loss comprises computing a similarity measure between the training image and the reconstructed image.

15. The system of claim 10, wherein the feature vector comprises a plurality of feature values encoding information associated with the pixel corresponding to the feature vector, and wherein applying the noise to each feature vector comprises perturbing one or more of the plurality of feature values.

3. One or more non-transitory computer-readable media storing computer-executable instructions that, when executed by one or more processors, cause the one or more processors to at least:
receive a training image;
generate, using a feature extraction model characterized by first parameters and taking the training image as input, noised feature vectors by:
determining a feature vector for individual pixels in the training image; and
applying noise to each feature vector to produce the noised feature vectors;
generate, using a reconstructor model taking the noised feature vectors as input, a reconstructed image, the reconstructor model characterized by second parameters;
determine a reconstruction loss by at least comparing the training image with the reconstructed image;
determine a noise loss using the noise applied to each feature vector, the noise characterized by the reconstruction loss; and
update the first parameters based on the noise loss.

17. The one or more non-transitory computer-readable media of claim 16, wherein the feature extraction model comprises a noiser network characterized by at least one of the of the first parameters.

18. The one or more non-transitory computer-readable media of claim 16, wherein the training image comprises an identifiable element.

19. The one or more non-transitory computer-readable media of claim 18, wherein the reconstructed image comprises an obfuscated element corresponding to the identifiable element of the training image.

20. The one or more non-transitory computer-readable media of claim 16, wherein determining a reconstruction loss comprises computing a similarity measure between the training image and the reconstructed image.
